(19) United States
(12) Patent Application Publication
(10) Pub. No.: US 2011/0281496 A1
(43) Pub. Date: Nov. 17, 2011

(54) POP-OUT PLAY STRUCTURE

(75) Inventors: Michael Welsh, Gates Mills, OH (US); Andy Carcioppolo, Chesterland, OH (US); Sam Cahill, Cleveland, OH (US)

(73) Assignee: Build A Dream Playhouses, LLC

(21) Appl. No.: 12/975,723

(22) Filed: Dec. 22, 2010

Related U.S. Application Data
(60) Provisional application No. 61/345,329, filed on May 17, 2010.

(51) Int. Cl. A63H 33/00; B31B 13/00

(52) U.S. Cl. 446/487; 493/374

(57) ABSTRACT

A life-size pop-out play structure is provided that includes a first foldable cardboard panel, a second foldable cardboard panel hingedly bound to the first panel along a first edge and one or more pop-out portions attached to the first and second cardboard panels. The portions are configured to lie flat against at least one of the first and second panels when the first and second panels are in a closed position and the pop-out portions are configured to pop-out when the first and second panels are separated by an angle.

The present disclosure relates to play structures, and more particularly to play structures made out of cardboard. It finds particular application in conjunction with corrugated cardboard foldable play structures, and will be described with particular reference thereto. However, it is to be appreciated that the present exemplary embodiments herein are also amenable to other like applications.

### BACKGROUND

Play structures for childhood pretend play have been used for many years and have taken the form of anything an imagination can create, from a tree house to club house to a lemonade stand. Children are excited by the limitless bounds their imaginations can explore in pretend play. Pretend play structures may be as simple as draping a sheet over two chairs or as intricate as wooden or plastic play houses that resemble castles, log cabins, princess quarters, etc.

Foldable cardboard is commonly used to create playhouses and other toy structures for children. Cardboard play structures provide an eco-friendly adventure for children and allow children to use their imaginations to create their own unique play space. Typically, these structures are constructed out of corrugated cardboard or other paperboard material and include outlines for cutting and folding the structure into the desired shape. The structure is then assembled and glued into final form. Such structures are often designed to create play spaces, such as houses, castles, vehicles, rockets, and the like.

Foldable structures such as those commonly known in the art generally require complicated and intricate assembly, such that one person cannot assembly the structure alone. Additionally, such cardboard play structures generally require an end user to perform additional lengthy steps, such as gluing or otherwise securing pieces together to ensure the play structure is sturdy enough for play. For example, U.S. Pat. No. 5,562,520 describes a multi-planar, fold-open play structure, with multiple panels that are unfolded form the base of the structure. However, the panels include tabs that must be glued or otherwise secured to the panels, therefore making it difficult to disassemble and store the play structure when finished/completed.

As such, there exists a need for safe, sturdy, easy to assembly play structures. Accordingly, it is an object herein to provide foldable, pop-up play structures with improved safety features and ease of assembly.

### SUMMARY OF THE DISCLOSURE

In accordance with one aspect of the disclosure a life-size pop-out play structure is provided. The play structure comprises a first foldable cardboard panel, a second foldable cardboard panel hingedly attached to the first panel along a first edge, and one or more pop-out portions attached to the first and second cardboard panels. The portions are configured to lie flat against at least one of the first and second panels when the first and second panels are in a closed position and the pop-out portions are configured to pop-out when the first and second panels are separated by an angle.

In accordance with another aspect of the disclosure a life-size pop-out play structure is provided. The pop-out play structure comprises a front panel having an inside surface and one or more page panels hingedly bound to the front panel at a vertex. The one or more page panels have a first surface facing the inside surface of the front panel and a second surface, opposite the first surface. The play structure further includes a back panel hingedly bound to the front panel and said one or more page panels at the vertex, the back panel having an inside surface facing the second surface of the one or more page panels, and at least one pop-out portion attached to the front panel inside surface and the front panel and at least one pop-out portion attached to the back panel inside surface and the second surface.

In accordance with yet another aspect of the disclosure a method for assembling a life size cardboard pop up play-structure is provided. The method comprises hingedly binding a first cardboard panel to a second cardboard panel along a first edge, attaching one or more pop-out portions to the first and second cardboard panels, and creating a first play space by spreading the first cardboard panel away from the second cardboard portion, forming an angle, wherein spreading the first cardboard panel away from the second cardboard panel causes the one or more pop-up portions to extend three dimensionally into the first play space.

### BRIEF DESCRIPTION OF THE DRAWINGS

FIG. 1 illustrates a side view of one aspect of a play structure according to one aspect of the present disclosure;

FIG. 2 illustrates a cardboard sheet with die cutouts of a pre-assembled kitchen play assembly;

FIG. 3 illustrates a cardboard sheet with die cutouts of a pre-assembled kitchen play assembly;

FIG. 4 illustrates a cardboard sheet with die cutouts of a pre-assembled kitchen play assembly;

FIG. 5 illustrates a flat formation of a kitchen play structure according to one aspect of the present disclosure;

FIG. 6 illustrates a side perspective view of one aspect of an assembly step for a kitchen play structure according to one aspect of the present disclosure;

FIG. 7 illustrates a side view of one aspect of an assembly step for a kitchen play structure according to another aspect of the present disclosure;

FIG. 8 illustrates a side view of an assembled kitchen play structure according to another aspect of the present disclosure;

FIG. 9(a) illustrates a side view an assembled kitchen play structure according to another aspect of the present disclosure;

FIG. 9(b) illustrates an close-up view of an assembled kitchen according to yet another aspect of the present disclosure;

FIG. 10 illustrates a cardboard sheet with die cutouts of a pre-assembled castle play assembly according to another aspect of the present disclosure;

FIG. 11 illustrates a cardboard sheet with die cutouts of a pre-assembled castle play assembly according to another aspect of the present disclosure;

FIG. 12 illustrates a cardboard sheet with die cutouts of a pre-assembled castle play assembly according to yet another aspect of the present disclosure;

FIG. 13 illustrates a flat formation of a castle play structure according to one aspect of the present disclosure;

FIG. 14 illustrates a side perspective view of one aspect of an assembly step for a castle play structure according to one aspect of the present disclosure;

FIG. 15 illustrates a side view of one aspect of an assembly step for a castle play structure according to another aspect of the present disclosure;

FIG. 16 illustrates a side view of an assembled castle play structure according to another aspect of the present disclosure;

FIG. 17(a) illustrates a side view an assembled kitchen play structure according to another aspect of the present disclosure;

FIG. 17(b) illustrates an close-up view of an assembled kitchen according to yet another aspect of the present disclosure;

FIG. 18 illustrates a side perspective view of one aspect of a play structure according to one aspect of the present disclosure;

FIG. 19 illustrates a side view of one aspect of a play structure according to another aspect of the present disclosure;

FIG. 20 illustrates a side view of one aspect of a play structure according to yet another aspect of the present disclosure; and

FIG. 21 illustrates a side view of one aspect of a play structure according to yet another aspect of the present disclosure.

### DETAILED DESCRIPTION

Pop-out play structures are provided that are intended for pretend play and utilize a unique structure and folding method to provide an essentially assembly-free play structure. The pop-out play structure encompass an intelligent, yet simple construction, which enables an end-user to simply “pop” open the structure, transforming an otherwise flat, inconspicuous piece of cardboard into a fully functional and multi-dimensional play environment. The pop-out play structures described herein couple ease of assembly with the ability for the playhouse to transform from flat, to fully assembled, in seconds, providing a unique and innovative design.

The pop-out play structures may comprise one or more cardboard panels. The pop-out play structure is preferably “life-size” such that children may actually enter into a particular play space. Each panel may be sized according to the general age group that the play structure is intended to serve. For example, if the structure is intended for children ages 3-5 the structure may be a different height than a structure intended for children 6-10, etc. According to one example, the cardboard panels are between 3.5 and 5 feet, and preferably between about 4 and 4.75 feet, although any desired height may be used. According to one embodiment, the play structures measure about 48″L×48″ H×6″ W packaged and about 48″H×96″ W×48″W fully opened. The nature of the material allows for the play structures to be colored and decorated by the “readers.” The pop-out play structures can be sold as a bound unit, similar to a life-size book, or modularly allowing consumers to piece together the play structure in sections. In its simplest form the pop-out play structure includes two panels that open up to an angle that creates the popping out action. The pop-out book is configured such that it is able to fold flat for storage and travel.

In accordance with a first aspect of the disclosure, a play structure is provided comprising at least two cardboard panels, each having a left and right vertical edge and a top and bottom horizontal edge. The two panels are attached in a book-like manner, in that the vertical edges of two panels are hingedly bound or attached to one another such that the panels can be opened and closed like a book. The panels comprise two sides, one or more being detailed to include features specific to the theme of the structure. When two panels are attached, the detailed sides of each panel face each other when closed in a book-like fashion. Opening the panels reveals a play space with three dimensional accessory portion that may pop out of the panels providing dimension to the play space.

The pop-out play structures may comprise single-walled corrugated cardboard such as B flute, B Flute 200 LB/WT, ECT-32 B, and/or double-walled corrugated cardboard. The cardboard may have graphics printed on one side for decorating purposes, similar to that of a coloring book. Alternatively, the cardboard may be plain, colored, pre-decorated, or may come with a decorating kit. Decorating kits may also be packaged and sold separately from the play structures, enabling children to pick out and customize the structures to fit each child's personality.

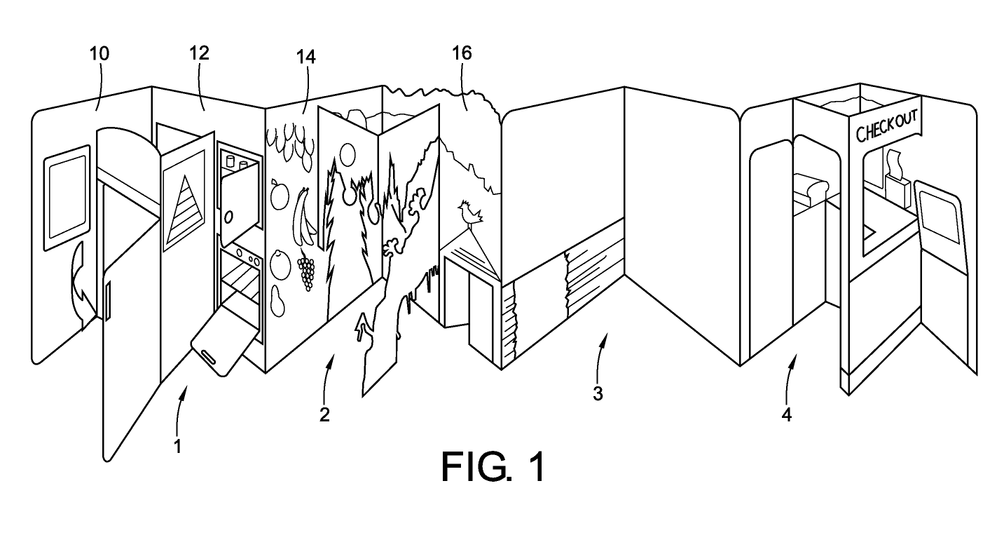

FIG. 1 illustrates a first exemplary aspect for the attachment of multiple panels in pop-out play structures, although numerous attachment variations are contemplated herein, including an accordion-type attachment scheme that involves attaching the panels edge-to-edge forming an accordion pattern. With this configuration, only one side of the panels, if any, need to be detailed, and the other side may remain plain. The first 10 and second 12 panels are attached along opposite vertical edges such that the detailed side of each panel faces the other. The panels may be lie stacked in a flat formation or may be opened to an angle when the panels are opened. The area inside the first and second panel forms a first play space 1, with each detailed side forming a “wall” of the play space. The play space may comprise any angle; however preferably the angle is greater than about 45°, and more preferably about 90° to provide the most spacious play space. When additional panels are included, the panels may be attached in a zig-zag formation with alternating angles, such that every two panels form another play space. For example, as illustrated in FIG. 1, a third panel 14 is attached to the second panel 12, the third panel bends in the opposite direction of the second panel 12, in a similar direction as the first panel 10. A fourth panel 16 may then be attached to bend back in the same direction as the second panel 12, forming a second angled play space 2. This attachment pattern may continue for any number of desired panels, creating a zigzag formation with a number of angled play spaces. The pop-out structure, having any number of panels, can then be collapsed like an accordion, such that each panel lies flat on the panel that comes before and/or after, or it can be extended, such that a number of play spaces are formed between adjacent panels.

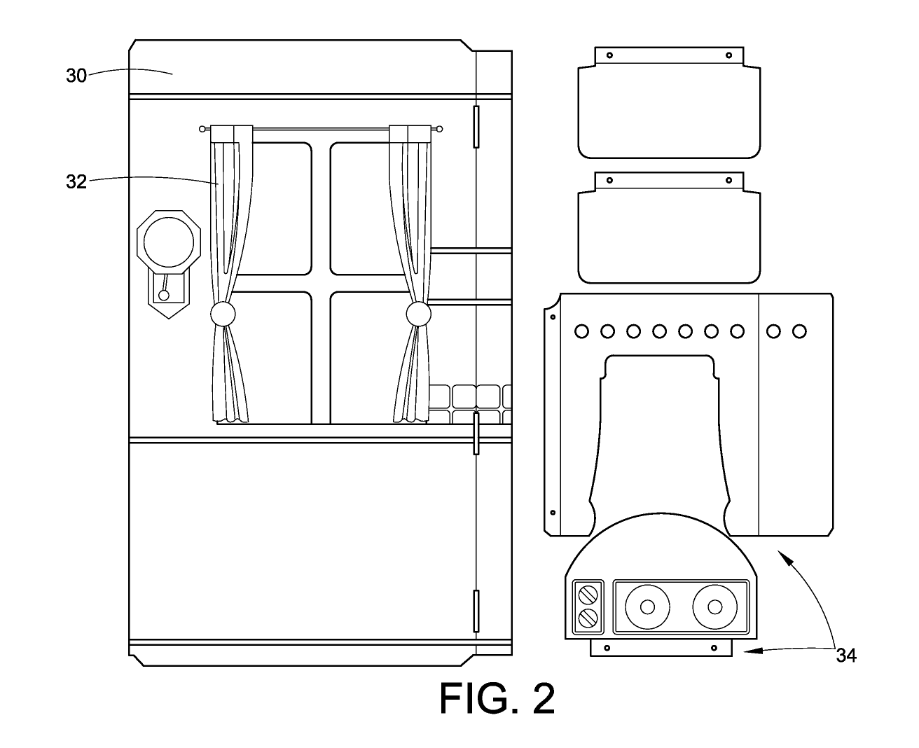

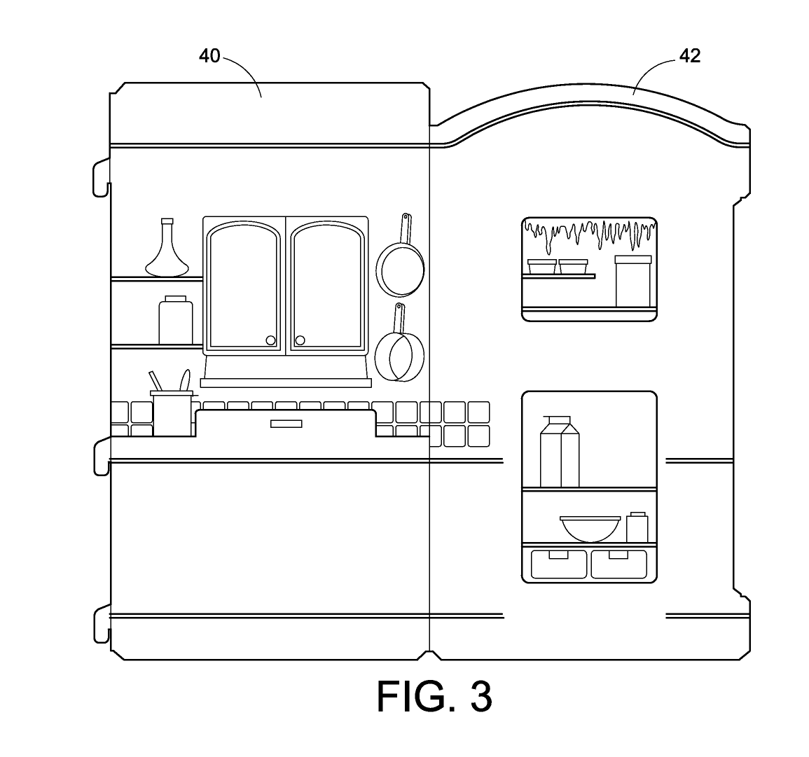

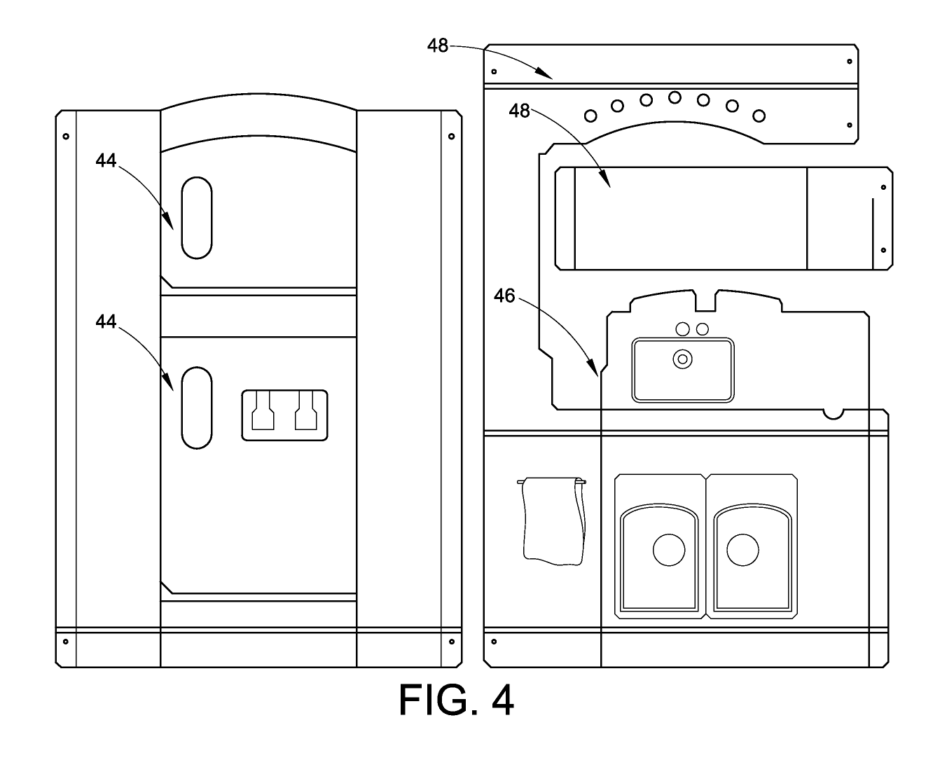

FIGS. 2-9(b), illustrate one exemplary aspect of the accordion-style pop-out structure having a kitchen theme. To provide easy assembly for end users, the structures are pre-assembled before being shipped. The play structures are formed by creating die cuts in cardboard sheets, preferably corrugated cardboard. (FIGS. 2-4). Generally, about 1.5 sheets are used to create a main body for the play structure. The remaining sheet pieces are generally used as accessory pieces that are either glued onto the structure or recycled as scrap. The pop-out structure represented by the die cut cardboard pieces of FIGS. 3-5 comprises three main panels (“walls”). FIG. 3 includes a first wall 30 with a window portion 32 and optional decorative features, such as drapes and a clock. The remainder of the sheet is used to develop optional pop-out accessories, such as a stove and oven piece 34. FIG. 3 further illustrates a cardboard panel comprising die cuts that form a second wall 40 including optional decorative features, such as an oven hood and cabinet portion, and third wall 42 that includes optional decorative features to illustrate contents of a refrigerator. The cardboard panel illustrated in FIG. 4 includes solely pop-out accessories, such as a refrigerator 44, sink and cabinet portion 46, and trim 48 for the first and second panels.

Once the panels are die cut, the main structure is stitched together with tabs and may be reinforced with adhesive. In one example, the adhesive consists of hot glue, such as 3M Scotchweld Hotmelt. The product assembly utilizes a series of tabs and slots that allow the panels to be stitched together at the edges of adjoining panels. A user may insert the tab of one section into the corresponding slot of another section, resulting in a “stitch.” The tabs are inserted through a slot and then folded down to lock the “stitch” in place. This “stitching” technique increases the structural rigidity and product safety.

Once the main structure is formed by attaching the panels together, the pop-out accessory portions may be strategically attached to the panels, such that the pieces are able to fold flat when the panels are stacked together and “pop-out” as the user opens the panels, or “pages”. The accessory pieces are preferably attached by an adhesive; however other attachment methods may alternatively be used, such as using the stitching method described above. The structure is configured to be broken down and set up numerous times to allow for continuous storage and use as needed. Once all the accessory pieces are secured to the main structure, the resulting play structure is complete and may be erected and broken down within seconds.

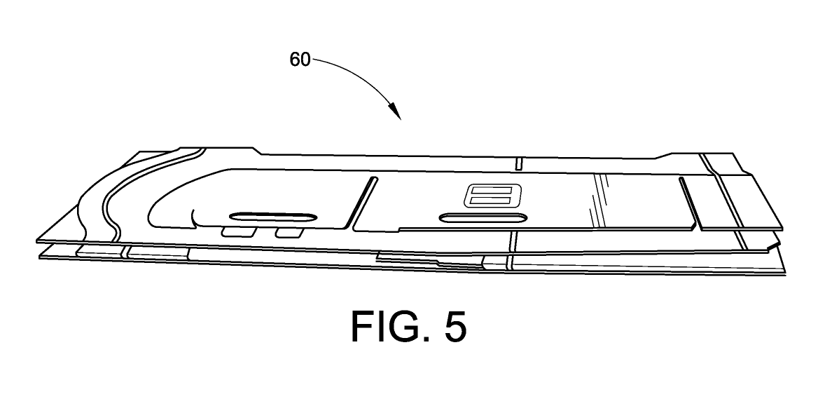

FIG. 5 illustrates the exemplary kitchen play structure 60, in its post-assembled flattened form, which allows for easy shipping, storage, and cleans up. The kitchen structure is collapsible into a thin, low profile stack that does not take up much space.

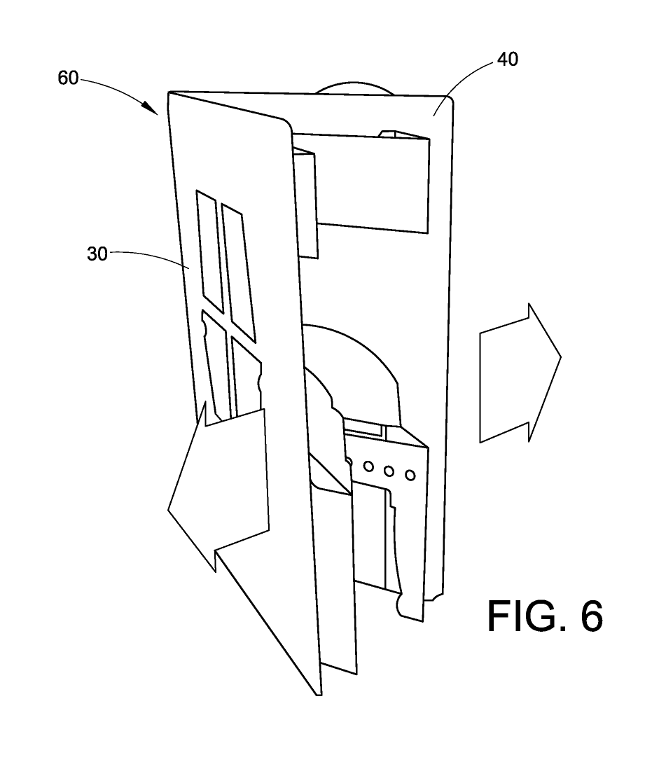

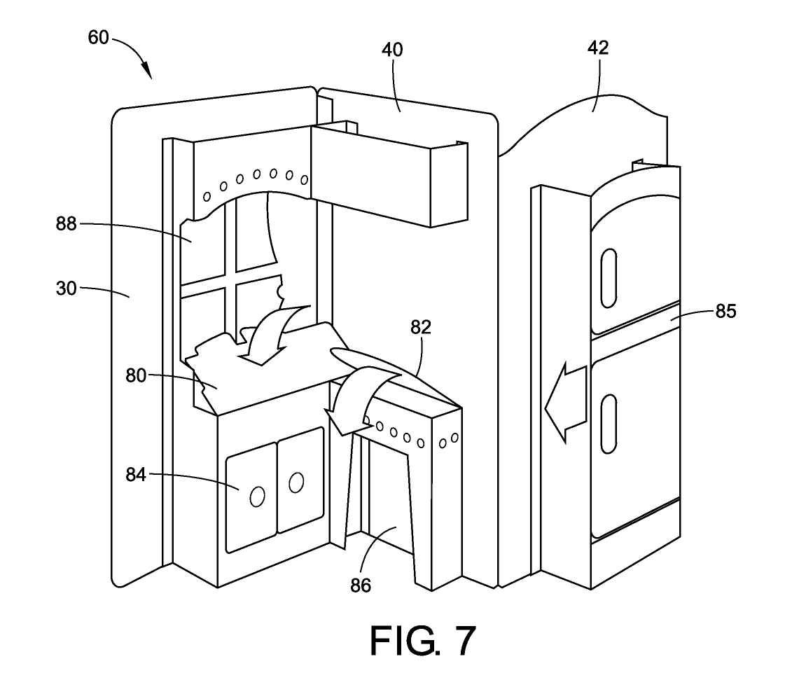

FIGS. 6-8 illustrate one exemplary method of erecting the exemplary kitchen play structure 60 starting in the flattened form shown in FIG. 5. As demonstrated in FIG. 6, the play structure is situated in a vertical position with the bottom panel edges resting on the ground. The first panel 30 and second panel 40 are spread apart to a desired degree, creating a first play space 1 between the first and second panels 30, 40. Preferably, the panels are expanded to form an approximately 90° angle to provide the most space for play. With the panels spread apart, the kitchen play structure 60 is able to stand independently, without any support assistance. Once the first 30 and second 40 panels are in place, additional panels (if included) may be unfolded. As illustrated in FIG. 7, a third panel 42 is unfolded from its initial position behind the second panel. The third panel may be opened to any desired degree, although generally a 90° angle is preferred. In FIG. 7, the third panel extends at a generally 90° angle from the second panel, creating an extension of the first play space 1. If, however, additional panels are provided, for instance a fourth panel (not shown), the third and fourth panels would be configured similar to the first 30 and second 40 panels, such that a second play space 2 is created there between. This pattern may continue for each panel included in the play structure 60.

As the panels are spread open forming a play space, integral accessory portions, such as a table, sink, cupboard, stove, etc., may “pop-out” of the panels to create three dimensional kitchen structural details. (FIG. 6). FIG. 7 illustrates the fully open first 30, second 40, and third 42 panels, with various 3-D accessory portions extending from the panels into the play space, adding dimension thereto. For example, the first panel 30 includes a sink portion 80 with a cupboard assembly 84 positioned below the sink 80. According to the present embodiment, the cupboard assembly 84 may two doors that may be pre-cut and folded to open and close, similar to a typical cupboard. The cupboard doors may include handle portions to assist in the opening and closing of the doors. Similarly, the second panel 40 may include a stove portion 82 having a hollow oven-like assembly 86 positioned below the stove 82. Additionally, portions above the sink and stove may also “pop-out” upon spreading the panels to create a decorative portion, such as the portion over a window 88 and a “hood” over the stove. In the exemplary kitchen structure illustrated herein, the window includes four “panes”, which may be formed as holes in the panel. The third panel 42 disclosed herein includes a refrigerator-like three dimensional accessory portion 85. The refrigerator 85 includes a freezer portion and a fresh food portion, each with individual doors capable of opening and closing. The doors may include a “handle”, which in FIG. 7 comprises a hole in the door that allows a user to open and close the door, although other forms of handles are also contemplated herein.

As illustrated in FIG. 7, the three-dimensional integral accessory portions may include foldable top flaps for forming flat surfaces, such as the sink flap 80 and stove flap 82. Once the accessory portions attached to the flat surfaces 80, 82 “pop-out” of the respective panels, the surfaces may be secured in place by folding the flaps down and securing the flaps in place, as demonstrated by the arrows in FIG. 7. The flat surfaces 80, 82 may be secured via the stitching method described above, an adhesive, or both. The surfaces are also beneficial to keep the “popped-out” accessory pieces in a proper three dimensional position.

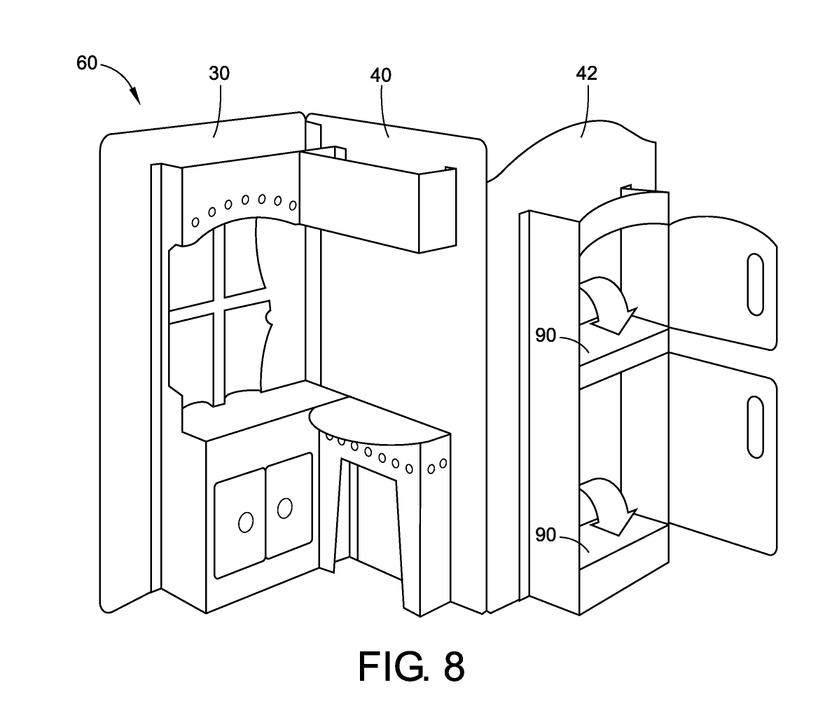

Similar to the top flaps described above, the refrigerator 85 may include shelves 90 as illustrated in FIG. 8. Once the refrigerator 85 “pops-out” of the panel, one or more shelves 90 may be folded down and secured into place. The shelves not only work to maintain the proper shape of the refrigerator, but also can support items that children may place on the shelves during a time of play.

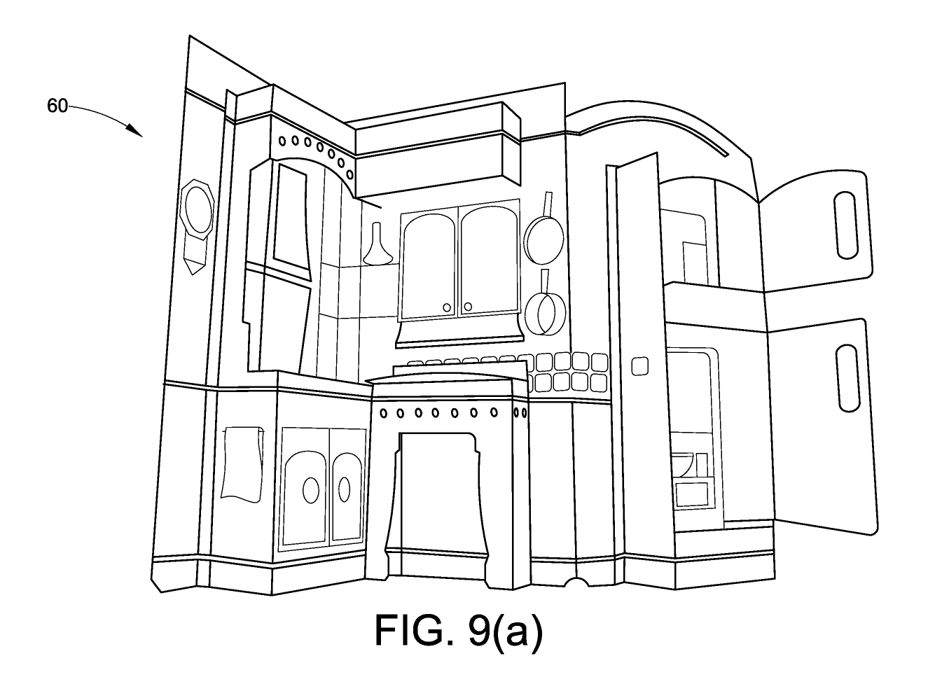

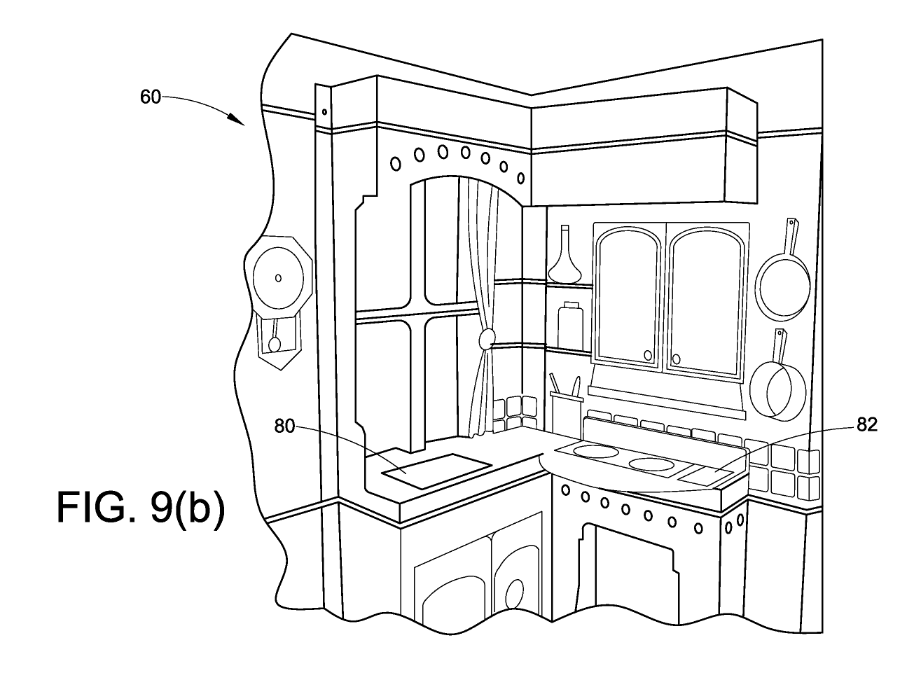

Once the panels of a play structure are opened, the pop-out accessories are “popped-out” and any flat surfaces/shelves are in place and secure, the play structure is completed and ready for play. FIGS. 9 (a) and (b) illustrate fully erected kitchen play structures including panels detailed with kitchen features. In the exemplary embodiment of FIG. 9(b), counter portion 80 is detailed to resemble a sink, and counter portion 82 is detailed to resemble a stove, although these details may be changed to include any other kitchen feature as desired.

To disassemble the structure, the counter-like flaps 80, 82, and 90 are lifted up and disassociated from the three-dimensional accessory piece it was keeping in place. As the panels are folded back together, the popped-out pieces flatten out against the panels, such that the entire play structure is flattened, as illustrated in FIG. 5.

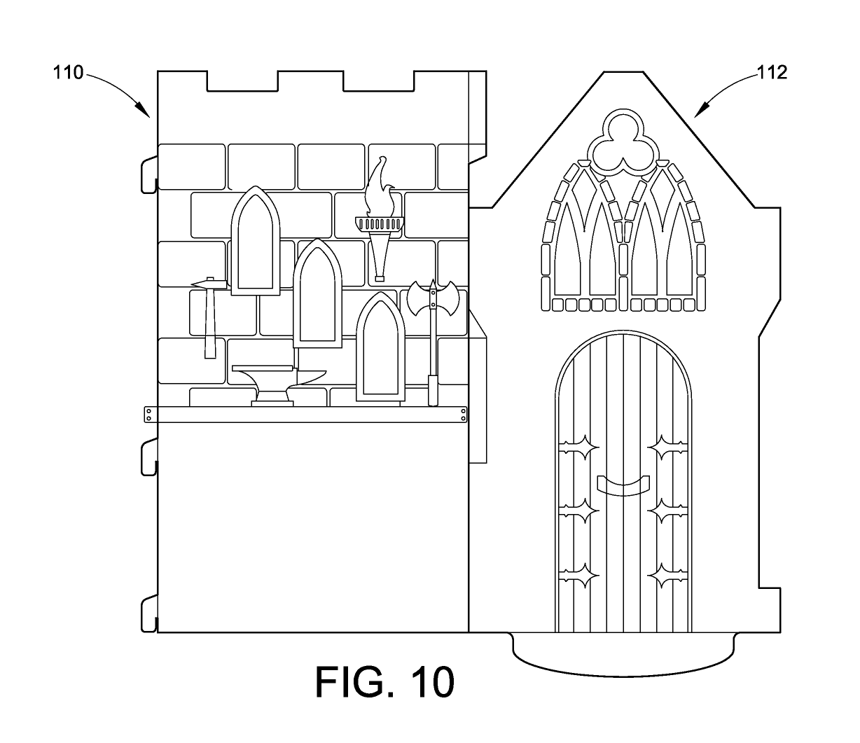

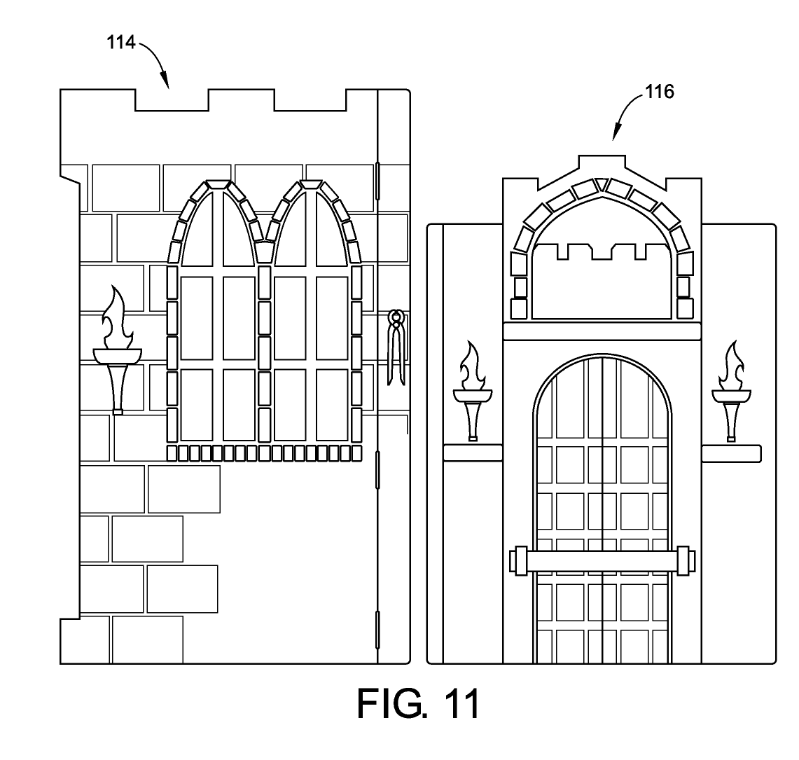

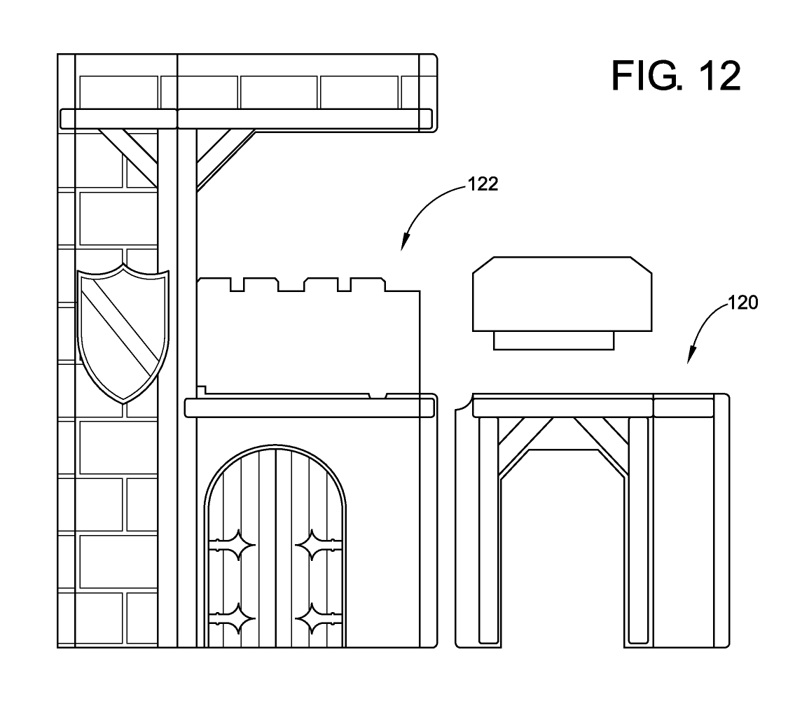

FIGS. 10-17, illustrate another exemplary aspect of the accordion-style pop-out structure having a castle theme. As with the kitchen themed pop-out structure, the castle pop-out structure is preferably formed out of die cut cardboard panels (FIGS. 10-12). FIG. 10 illustrates a first cardboard sheet comprised of die cuts for a first panel 110, and a second panel 112. The panels may comprise die cuts for any castle-themed features desired, such as windows, doors, etc. A second cardboard panel (FIG. 11) may then include a third panel 114, and the excess cardboard may be used for optional accessory pieces, such as a gated entrance way 116, and interior structural pieces (FIG. 12), such as a table 120 and wall 122.

Once the cardboard panels to be included in the castle play structure are die cut, the main castle structure 100 is formed by stitching each panel together with tabs, which may be reinforced with adhesive. Once the main structure 100 is formed, the pop-out accessory pieces, such as for example, the entrance way, wall, and table described above, may be strategically attached to the panels as described above, such that the pieces are able to fold flat when the panels are stacked together and “pop-out” as the user opens the panels, or “pages”. Once all the accessory pieces are secured to the main structure, the resulting play structure is complete and may be erected and broken down within seconds.

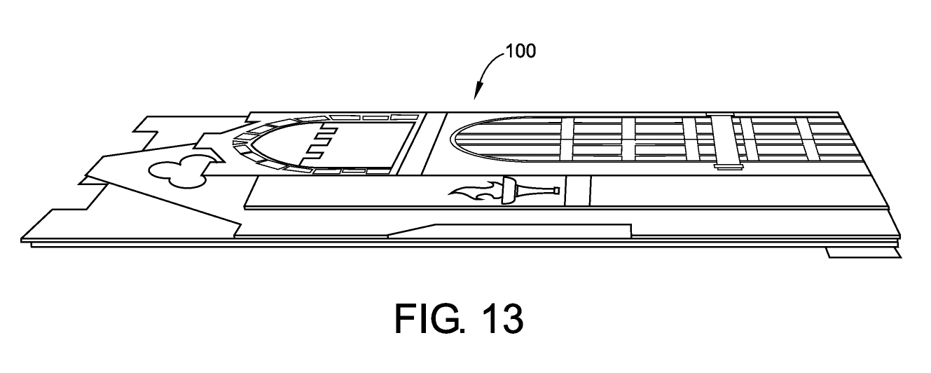

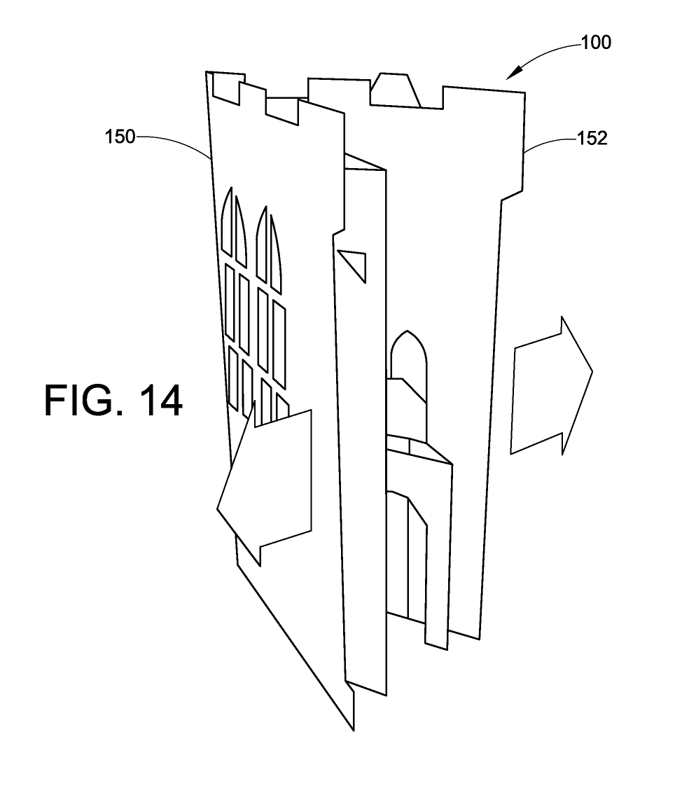

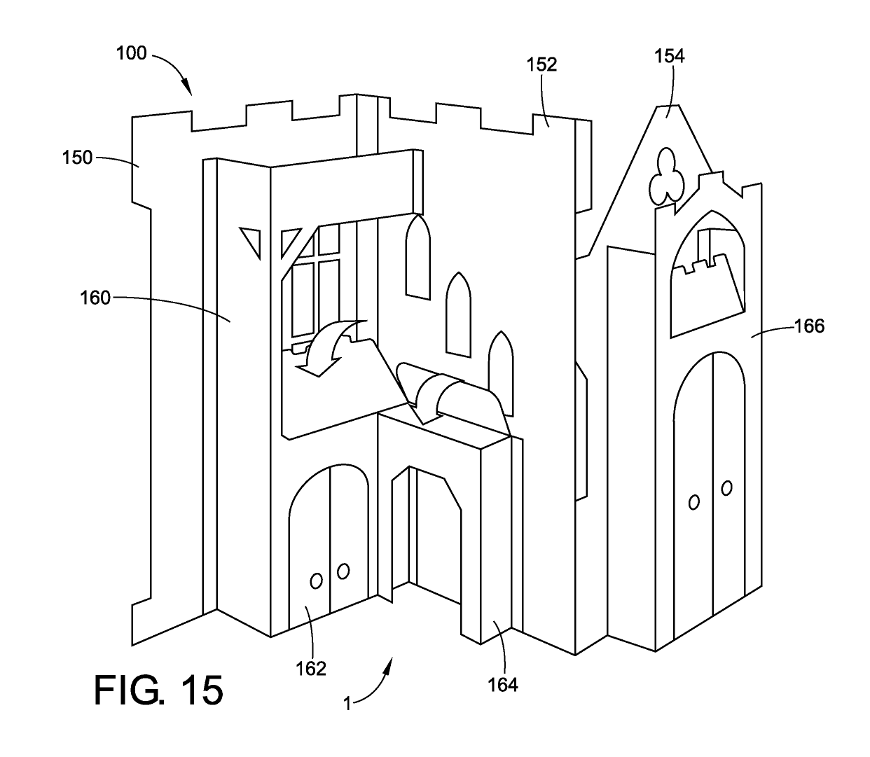

FIG. 13 illustrates one embodiment of a fully assembled castle play structure 100 in a flattened position for storage and shipment. Once the castle structure is ready to be erected, the castle may be vertically positioned for set up, illustrated in FIG. 14. A first panel 150 and a second panel 152 are then opened and separated from one another to a particular degree, forming a first play space 1. Similar to the kitchen play space described above, as the panels are spread open forming a play space, integral accessory portions for the castle may unfold from flat positions and “pop-out” of the panels to create three dimensional castle structural details. (FIG. 14). Once the first 150 and second 152 panels are in place, additional panels may be unfolded in a similar manner. For instance a third panel 154, as illustrated in FIG. 15, may be extended away from the second panel at any desired degree; however a generally 90° angle is preferred for an optimal play space. FIG. 15 illustrates the fully open first 30, second 40, and third 42 panels, with various three dimensional accessory portions extending from the panels into the play space, adding dimension thereto. For example, the first panel 150 includes a wall hutch portion 160 with a cupboard assembly 162 positioned below the hutch 160. According to the present embodiment, the cupboard assembly 162 may include two doors that may be pre-cut and folded to open and close, similar to a typical cupboard with handles as described above. Similarly, the second panel 152 may include a table portion 164 having a hollow storage area positioned below the stove 164. The third panel 154 disclosed herein may include an arched three dimensional gateway 166. The entrance way may include a doorway or drawbridge, capable of opening and closing.

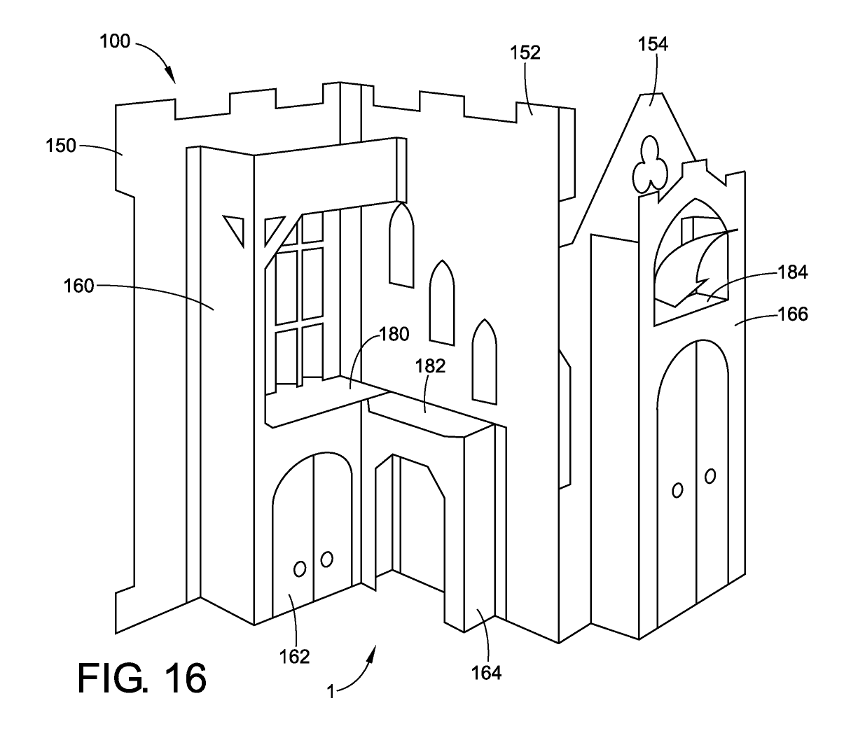

As illustrated in FIGS. 15 and 16, the optional three dimensional integral accessory portions include foldable flat surface flaps, similar to the kitchen structure, for forming flat surface portions, such as a counter-top flap 180 and table top flap 182. Once the accessory portions attached to the flat surface flaps 180, 182 “pop-out” of the respective panels, the flaps may be secured in place by folding the flaps down and securing the flaps in place, as demonstrated by the arrows. Specifically, the counter-top flap 180 may be folded down and locked through a window provided in the first panel. The table top flap 182 is similarly folded down and tucked under a small tab located on the counter-top flap 180, securing the table top 182 in place. When the arched gated section is folded out, a shelf 184 above the gate may be folded down and locked through a window located on the third panel 154. The flat surface flaps are beneficial, not only for providing a place for children to use for play, but also to keep the “popped-out” accessory pieces in a proper three dimensional position.

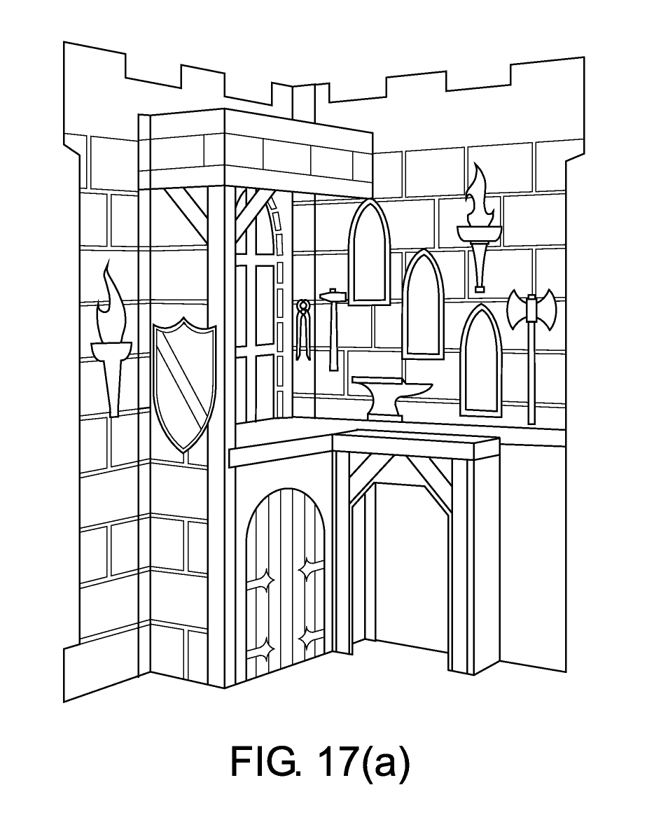

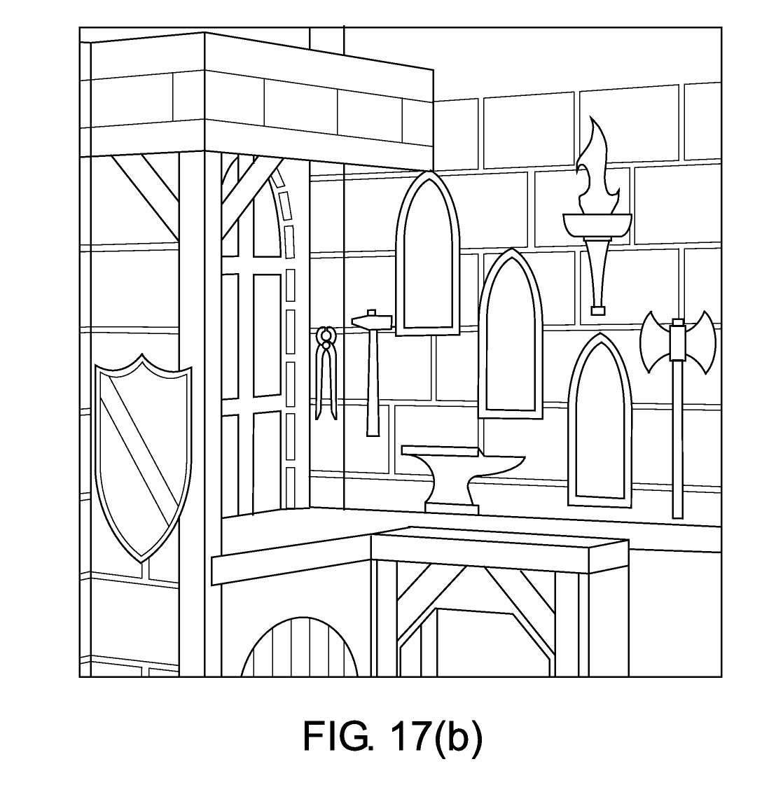

FIGS. 17(a) and (b) illustrate a fully erected example of a castle play structure according to the present disclosure, complete panel walls having castle feature designs thereon. The specific examples herein include wall features such as brick, torches, and a shield. It is to be recognized that any desired designs are contemplated herein, and these designs are not intended to be limiting in any way.

To disassemble the structure, the flat surface portions flaps 180, 182, and 184 are lifted up and disassociated from the three-dimensional accessory piece it was keeping in place. As the panels are folded back together, the popped-out pieces flatten out against the panels, such that the entire play structure is flattened, as illustrated in FIG. 10.

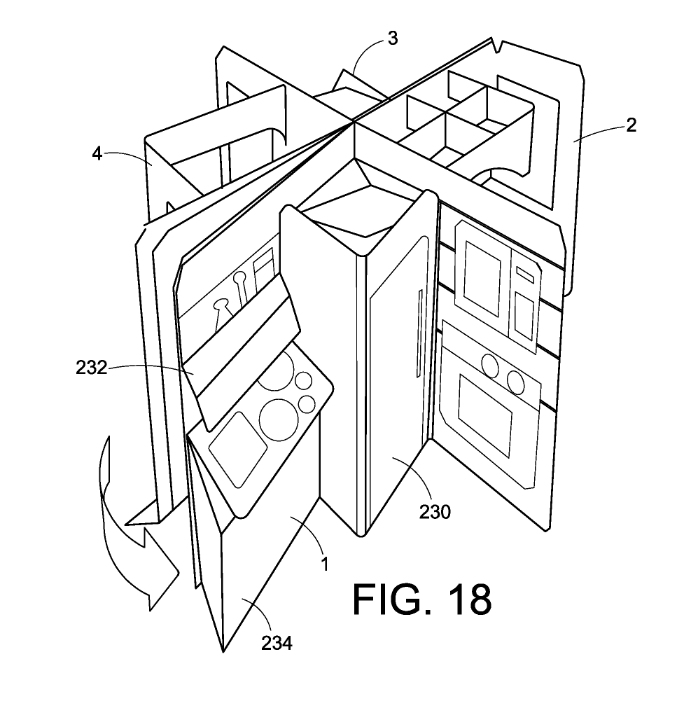

Another exemplary method of attaching multiple panels is a book-type method, as illustrated in FIG. 18. With this method of attachment, generally both sides of the panels that represent the “pages” of the book are detailed, while those representing the “cover” only need detailing on one side. The cover panel 200 may be attached to the first page panel 202, in a similar manner as described above, with the detailed side of the cover panel 200 facing one of the detailed sides of the first page panel 202. The first page panel 202 may open at an angle away from panel 200 to form a first play space 1. As additional page panels are added to the structure, however, rather than attaching in an accordion-like fashion described above, the panels are attached at a common vertex 222, similar to pages in a book. The panels preferably include details on each side, such that each page-like panel is associated with at least one, but preferably two play spaces. For example, a second page panel 204 is attached at the vertex 222 and includes a detailed side facing the detailed side of the first page panel 202 that is opposite the side that forms the first play space 1. As the second page panel 204 is opened at an angle away from the first page panel 202, a second play space 2 is formed. A third page panel 206 may also attach to the vertex 222 and open away from the second page panel at any angle to form a third play space 3. Additional panels may be included to form additional play spaces, as desired by an end user. Finally, a “back cover” panel 208 may be attached to the vertex 222 and opened at an angle away from the previous panel to form a final play space (fourth play space 4 as illustrated in FIG. 18). The non-detailed sides of the cover pages may rest against each other when the “book” is fully opened. When the book is closed, each panel may be “closed” against a preceding panel, similar to closing a book, such that the non-detailed sides of the first and final panels create the cover of the book.

As illustrated in FIG. 18, the maximum number of fully opened play spaces (90 degree angles) that one book structure may comprise is four. If more than three page panels are included, particular panels may be closed to open up the play space created by other panels. Each panel may be folded up against its preceding panel in succession, until the book is “closed”.

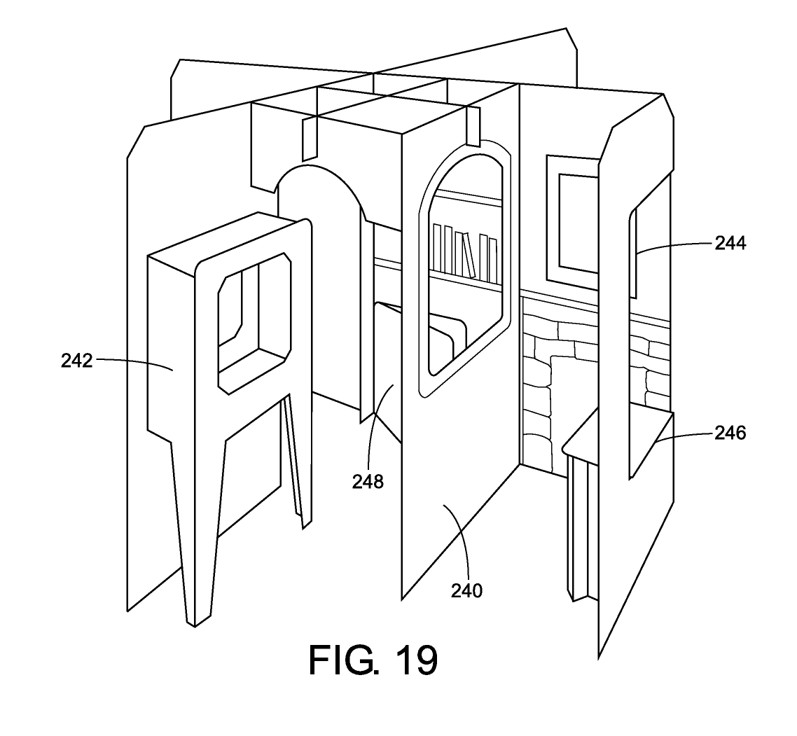

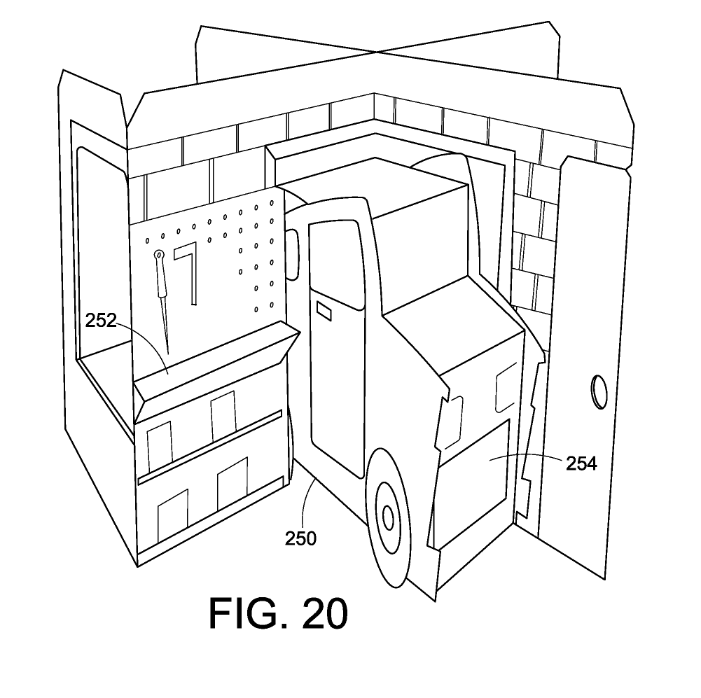

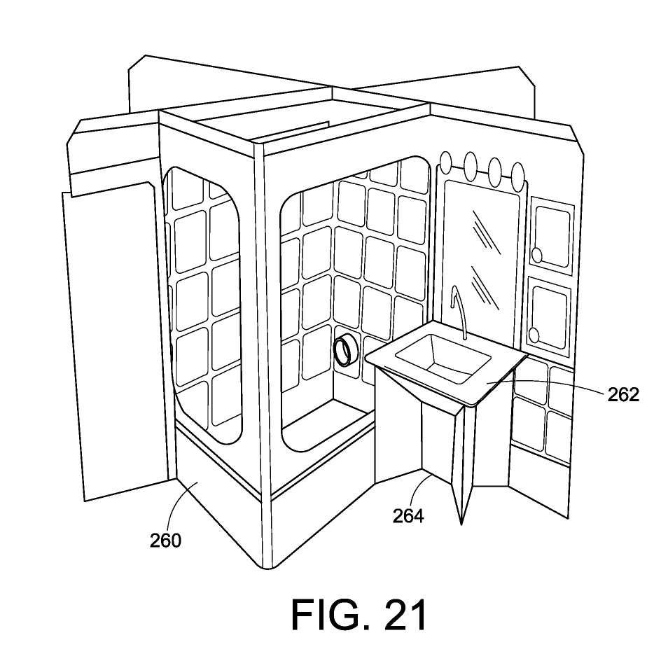

FIGS. 18-21 illustrate various exemplary themed play spaces, including a kitchen (FIG. 18), a living room (FIG. 19), a garage (FIG. 20) and a bathroom (FIG. 21). According to the kitchen of FIG. 18, upon opening the kitchen pages to an angle, such as a generally 90° angle, a refrigerator 230 “pops out” of the corner of the room and a range top/sink 232 folds down from the wall. The bottom portion of the range/sink 234 may be attached to the refrigerator, such that it is configured to pop out with the refrigerator as the book page panels are opened. The kitchen may also include various other kitchen themed accessories such as a wall oven and microwave that are complete with functional doors. These features encourage pretend play and are completed with the appropriate graphics and/or decorating accessories. The refrigerator door may open and allow the “readers” to walk though and flow into the next room.

An exemplary living room, illustrated in FIG. 19, may provide a divider wall structure 240 for a sense of enclosure, which also breaks up the room into sections. A TV 242 may be configured to line up with the microwave hole from the kitchen, which allows for the “readers” to stand in the kitchen and pretend like they are in the TV 242. There may also include a picture frame 244 that allows “readers” to create their own paintings on standard printer paper and interchange their own artwork as desired. According to one embodiment, the picture frame measures approximately 8.5″×11″. The living room may also include a bay window 246 with a window seat. As with the flat surface portions described above, the window seat may fold down and attached by stitching a tab through a provided slot. Located on the wall opposite to that shared with the kitchen, there may be a bookshelf and secret hatch 248 below the bookshelf that may lead out of the play space and/or into a new play space.

FIG. 20 illustrates an exemplary garage play space, including a car portion 250 that “pops out” from the garage walls as the walls spread open. The exemplary car 250 includes a roof and a hood that may include a door panel 254 capable of opening and closing. The door panel 245 may lead out of the play space and/or into a new play space. The garage may further include a pop-out workbench 252, which may fold down from the walls as the panels are spread.

An exemplary bathroom play space is illustrated in FIG. 21. The bathroom may include a bath/shower 260 that “pops out” of the corner when the panels are opened to an angle, preferably about ninety degrees. A sink top 262 may flip down over a base 264 that pops out of the wall, and the top may be secured to the base 262 by stitching one or more tabs through corresponding slots. The bathroom may also include functional cupboards and tubes used for knobs.

These exemplary play spaces may be designed to be put side-by-side, or back-to-back when fully open. This allows the “readers” to cycle through the play spaces of the playhouse, similar to volumes of a book. Through unique design the typical pop-out book transforms into a play environment.

The details above describe the pop-out play structure disclosed herein in terms of rooms of a house and a castle; however, these examples are non-exhaustive and are provided for exemplary purposes only. The pop-out play structure can illustrate any literary work/movie or TV show/video game/artwork/fold-out design, including but not limited to a kitchen, workshop, pizza parlor, hair salon, bakery, outdoors, modular castle, fantasy, space, safari, school, hospital, market, veterinarian clinic, pet store, mall, boutique store, grocery store, garden, pirate, train station, fire station, police station, cities, cultures, educational stories, cops and robbers, cowboys and Indians, army/military, secret agent, wizards, vampires, zombies, kings and queens, princess and prince, Jurassic, museum, car wash, gas station, sea, underwater, pilot, houses, transportation, fairies/fairy tales, nursery rhymes, landscapes (jungle, desert, mountains, ocean, beach, tropical, polar), health and nutrition, western, farm/barnyard, world tour (countries/famous landmarks), U.S. history, world history, science, ancient Rome, Acropolis, Egypt (pyramids and tombs), dinosaurs, holiday themes, town themes, physical education, forest, tree house, etc.

The pop-out play structures according to the present disclosure may be modular in design. The pop-out play structures, however, are not limited to being sold modularly and may be sold in pairs, series, chapters, etc., similar to a book. Individually, the pop-out play structures may be a volume of a themed series. When all of the volumes are bound together they will complete the series, which will also complete the playhouse. For example, a house-themed concept may be comprised of a workshop/garage, an outdoor patio, a kitchen, a living room, a bathroom, and a laundry room. One particular embodiment of this series would be broken down into the following volumes: Volume 1—workshot/garage & outdoor patio, Volume 2—kitchen & living room, and Volume 3—bathroom & laundry room.

The volumes may function as play structures on their own without being part of a series. For example, Volume 2 may be purchased separately from Volumes 1 & 3. However, when all the volumes are brought together they create the full house, or other themed, experience. If a consumer purchases Volume 2 individually, they would have, for example, a kitchen and living room. The play structure may come in the form of a book, and when opened, pages 1 & 2 would create the kitchen and pages 3 & 4 would create the living room, etc. Thus, one set of pages may create one room.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A life-size pop-out play structure comprising;
a first foldable cardboard panel;
a second foldable cardboard panel hingedly bound to said first panel along a first edge; and
one or more pop-out portions attached to said first and second cardboard panels, wherein said portions are configured to lie flat against at least one of said first and second panels when said first and second panels are in a closed position and said pop-out portions are configured to pop-out when said first and second panels are separated by an angle.

2. The life size pop-out play structure of claim 1, wherein the pop-out play structure is configured to fold flat.

3. The life-size pop-out play structure of claim 1, wherein the first and second cardboard panels are bound by stitching together tabs and slots located on the panels.

4. The life size pop-out play structure of claim 1, wherein said angle defines a first play space.

5. The life size pop-out play structure of claim 4, wherein the angle greater than approximately 45°.

6. The life size pop-out play structure of claim 5, wherein said angle is approximately 90°.

7. The life size pop-out play structure of claim 1, wherein said play structure further includes a third cardboard panel.

8. The life size pop-out play structure of claim 7, wherein said third cardboard panel includes one or more pop-up portions configured to lie flat against said third panel when said third panel is in a closed position and configured to pop-out three dimensionally when said third panel forms an angle with said second panel.

9. The life size pop-out play structure of claim 7, wherein said third cardboard panel is hingedly bound to the second cardboard panel along a second edge, opposite said first edge.

10. The life size pop-out play structure according to claim 9, further including a fourth cardboard panel hingedly bound to said third cardboard panel along a third edge, opposite said second edge.

11. The life size pop-up play structure of claim 10, wherein said pop-out play structure comprises an accordion-like shape.

12. The life size pop-up play structure of claim 1, wherein said play structure comprises one of a castle and a kitchen.

13. The life size pop-up play structure of claim 1, wherein said cardboard is corrugated.

14. A life-size pop-out play structure comprising:
a front panel having an inside surface;
one or more page panels hingedly bound to said front panel at a vertex, said one or more page panels having a first surface facing said inside surface of said front panel and a second surface, opposite said first surface;
a back panel hingedly bound to said front panel and said one or more page panels at said vertex, said back panel having an inside surface facing the second surface of said one or more page panels; and
at least one pop-out portion attached to said front panel inside surface and said front panel and at least one pop-out portion attached to said back panel inside surface and said second surface.

15. The life-size pop-out play structure of claim 15, wherein said pop-up portions are configured to lie flat when attached to panels in a closed position and configured to pop-out three dimensionally when attached to panels open to an angle.

16. A method for assembling a life size cardboard pop up play-structure, said method comprising:
hingedly binding a first cardboard panel to a second cardboard panel along a first edge;
attaching one or more pop-out portions to said first and second cardboard panels; and
creating a first play space by spreading said first cardboard panel away from said second cardboard portion, forming an angle, wherein spreading the first cardboard panel away from the second cardboard panel causes said one or more pop-up portions to extend three dimensionally into the first play space.

17. The method according to claim 16, further including hingedly binding a third cardboard panel to said second cardboard panel along a second edge, opposite said first edge, said third cardboard panel including one or more pop-out portions.

18. The method according to claim 17, further including spreading said third cardboard panel away from said second cardboard panel at a second angle and extending said one or more pop-out portions three dimensionally away from said third panel.

19. The method according to claim 18, further including creating a second play space by hingedly binding a fourth cardboard panel to said third cardboard panel along a third edge, opposite said second edge, and spreading said fourth cardboard panel away from said third cardboard panel at a third angle.

20. The method according to claim 19, wherein said first, second, and third angles are greater than about a 45° angle.
